(19) United States
(12) Patent Application Publication
(10) Pub. No.: US 2016/0362830 A1
(43) Pub. Date: Dec. 15, 2016

(54) VENTED CLOTHES DRYER WITH PASSIVE HEAT RECOVERY

(71) Applicant: J R Thermal, LLC, Austin, TX (US)

(72) Inventor: Jeremy Rice, Austin, TX (US)

(73) Assignee: J R Thermal, LLC, Austin, TX (US)

(21) Appl. No.: 15/172,513

(22) Filed: Jun. 3, 2016

Related U.S. Application Data
(60) Provisional application No. 62/173,121, filed on Jun. 9, 2015.
(60) Provisional application No. 62/268,240, filed on Dec. 16, 2015.

(51) Int. Cl. D06F 58/26; F26B 23/00; D06F 58/02

(52) U.S. Cl. CPC D06F 58/26; D06F 58/02; F26B 23/002

(57) ABSTRACT

This invention involves a heat recovery system implemented in a vented clothes dryer, through the use of a passive, indirect heat exchanger. The recovered waste heat is used to preheat the air into the dryer's heater, thus enabling lower total energy consumption per load. The heat recovery unit is integrated within the boundaries of the dryer's cabinet in such a way that preheated air enters the heating tube or heating element ducting.

### CROSS-REFERENCE TO RELATED APPLICATIONS

The present application claims priority from prior U.S. Provisional Patent Application Ser. No. 62/173,121 filed Jun. 9, 2015 entitled “VENTED CLOTHES DRYER WITH PASSIVE HEAT RECOVERY” and Provisional Patent Application Ser. No. 62/268,240 filed Dec. 16, 2015 entitled “VENTED CLOTHES DRYER WITH PASSIVE HEAT RECOVERY”, the entire contents of each of which are incorporated herein by reference.

### BACKGROUND

As of 2010, clothes dryers account for nearly 6% of the total residential electricity use in the United States. Approximately 99% of the clothes dryers used in the United States require a vent. A schematic of a typical vented clothes dryer is presented in FIG. 1, in which, relatively dry and cool ambient air 100 enters the dryer, and is heated as it passes through a heating tube 101, and into a drum 102. The damp clothes are inside the drum 102, which is typically rotated around a horizontal axis. In the drum 102, the air enters at a high temperature. As the air picks up moisture from the clothes, it cools as a result of a nearly adiabatic evaporation process. The warm and humid air exiting the drum 102 is pulled by a blower 103 and then exhausted 104 from the dryer, and ultimately out of the building in which the dryer is contained.

In a representative use case of a normal operating condition, the entering air 100 enters the dryer at 24° C., and is heated to 84° C. prior to entering the drum 102. The hot dry air enters the drum 102, picks up moisture and cools, exits the drum 102 and then exhausts from the dryer at 40° C. The difference between the exhaust 104 temperature and the intake 101 temperature is 16° C., compared to the 60° C. temperature difference between the intake air 101 and the air entering the drum 102. If heat recovery is utilized, the intake air temperature 101 could be raised by a maximum of 16° C., thus reducing the required heat load by about 27% to obtain the same drum 102 inlet temperature.

A schematic of heat recovery implemented in a clothes dryer is presented in FIG. 2. Intake air 100 passes through a heat exchanger 105 and then through the heating tube 101. The hot air then enters the drum 102, is pulled through the blower 103 and then flows through the heat exchanger 105 prior to exiting the system. In this schematic, implementations that position the heat exchanger 105 outside of the dryer's cabinet can make it difficult to ensure that the intake air 100 passes through the heat exchanger 105 prior to entering the dryer cabinet.

### SUMMARY OF THE INVENTION

The present invention details a system to recover part of the waste heat of a vented clothes dryer to preheat the air that enters into the dryer's heating tube. Preheating the air into the heating tube can reduce the total energy consumption of a drying cycle by upwards of nearly thirty percent. The heat recovery system can be utilized by both an electric resistance heat source as well as a combustion gas heat source. The system incorporates a passive, indirect heat exchanger, which is implemented within the dryer's cabinet. The drum's leaving air is directly ducted through the heat exchanger, where it pre-heats the relatively cool and dry air that enters the dryer's heating tube and then passes on to the dryer's drum.

The intake air can be pulled through the heat exchanger by several methods. For example, in the first method, a negative pressure is induced inside the entire dryer cabinet, by the suction created from the air pulled through the heating tube. In a second method, an additional fan is added which pulls the intake air through the heat exchanger. In a third method, the heat exchanger is directly baffled to the heating element duct. Other methods are also contemplated.

For a dryer with a front lint trap, the heat exchanger may be positioned in the front of the cabinet, between the drum/lint trap and the blower's intake. The heat exchanger may be located at the front of the cabinet, allowing for easy access, for cleaning and removing the device. Additionally, the heat exchanger may be positioned in the space below the drum of the dryer on the opposing side of the cabinet as the motor. In this location, the relatively cool and dry air can enter the heat exchanger from inside the cabinet, and be directly ducted to the heating element ducting.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is a schematic drawing of a vented clothes dryer along with the temperature profile, in accordance with prior art;

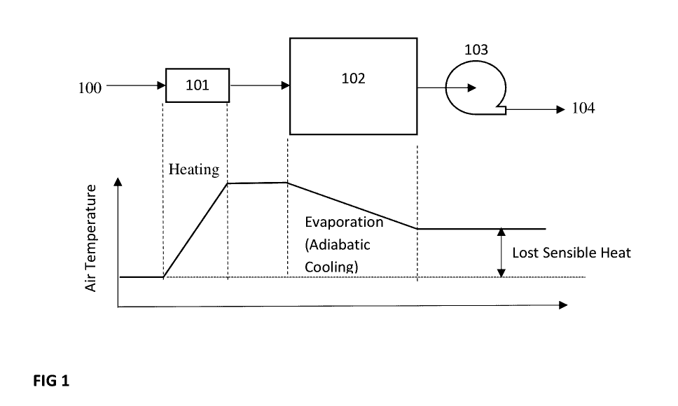

FIG. 2 is a schematic drawing of a vented clothes dryer with heat recovery in accordance with prior art;

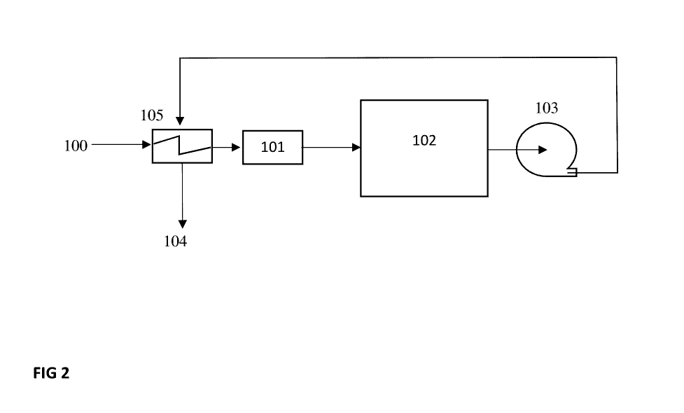

FIG. 3 is a schematic drawing of a vented clothes dryer with a heat recovery unit, in one embodiment of the present invention;

FIG. 4 is a isometric schematic drawing of the dryer cabinet in one embodiment present invention;

FIG. 5 is a schematic of a cross-sectional view of the heat exchanger in one embodiment of the present invention;

FIG. 6 is a rear isometric schematic drawing of the dryer cabinet in one embodiment of the present invention;

FIG. 7 is a rear isometric schematic drawing of the dryer cabinet in a second embodiment of the present invention;

FIG. 8 is a rear isometric schematic drawing of the dryer cabinet in a third embodiment of the present invention;

FIG. 9 is a rear cross-sectional view of the airflow pattern in a third embodiment of the present invention;

FIG. 10 is a front isometric view of the dryer cabinet in a fourth embodiment of the present invention

FIG. 11 is a cross-sectional view of the dryer cabinet in a fourth embodiment of the invention using a booster fan;

FIG. 12 is a cross-sectional view of the dryer cabinet in a fifth embodiment of the present invention without the use of a booster fan;

FIG. 13A is a front isometric view of the dryer cabinet in a sixth embodiment of the present invention and FIG. 13B is a rear isometric view;

FIG. 14 is a cross-sectional view of the dryer cabinet in a sixth embodiment of the present invention;

FIG. 15 is a front isometric view of the dryer cabinet in a sixth embodiment of the present invention with the lint filter removed;

FIG. 16 is a rear isometric view of the dryer cabinet in a seventh embodiment of the present invention;

FIG. 17 is a cross-sectional view of the heating element and drum intake ducting in the seventh embodiment of the present invention; and

FIG. 18 is block diagram of an embodiment of the present invention with preheated dry and humid air mixing prior to exhausting the dryer.

### DETAILED DESCRIPTION

The present invention is directed to an apparatus and method for heat recovery implemented in a vented clothes dryer through the use of a passive, indirect heat exchanger. The configuration and use of the presently preferred embodiments are discussed in detail below. It should be appreciated, however, that the present invention provides many applicable inventive concepts that can be embodied in a wide variety of contexts other than devices for vented clothes dryers. Accordingly, the specific embodiments discussed are merely illustrative of specific ways to make and use the invention, and do not limit the scope of the invention.

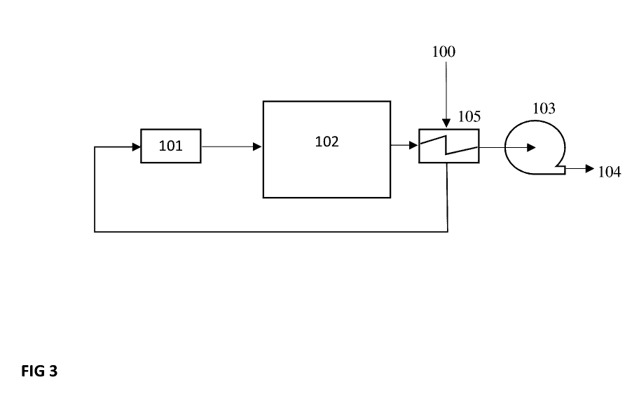

A general schematic of one embodiment of the present invention is presented in FIG. 3. In this schematic, intake air 100 passes through a heat recovery heat exchanger 105, before entering the heating tube 101. The heating tube 101 will have a heater inside, such as a resistive electrical heater or burner to combust natural gas or propane. Hot, dry air leaving the heating tube 101 passes into the drum 102, exhausting from the drum 102 as warm humid air. The warm humid air then passes through the heat exchanger 105, where it exchanges heat with the intake air 100. This heat exchanger 105 is an indirect heat exchanger, in which the intake air 100 and warm humid air do not directly come into contact with each other, and are separated by metal foil or a plastic plate. A small amount of air mixing may be permissible inside the heat exchanger, but will generally degrade the overall system efficiency. The heat exchanger may be a stacked fin assembly, a folded fin and flattened tube assembly or other assembly known in the art. After the warm humid air exits the heat exchanger 105, it enters the blower 103 and then exhausts from the dryer's cabinet 104.

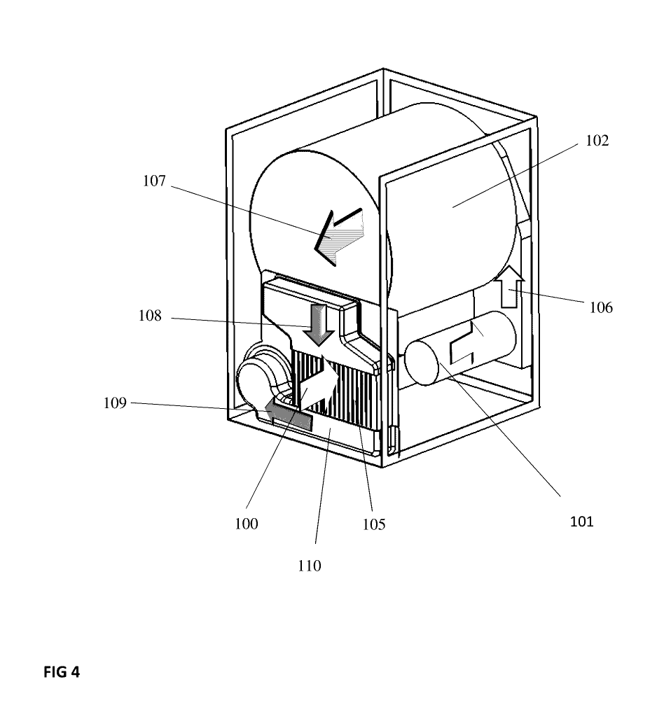

A three dimensional representation of the same embodiment is presented in FIG. 4. In this embodiment, air 106 enters the drum 102 from the rear, and flows 107 from the back to the front before passing through a lint trap (not shown) in the front/bottom of the drum 102. After exiting the lint trap, air 108 flows generally downward through a heat exchanger 105, where it exits and flows 109 into the blower. In this implementation, the heat exchanger 105 or heat recovery unit is a cross-flow type, where warm humid air 108 generally flows from top to bottom and intake air 100 generally flows from front to back. Since the warm humid air 108 releases heat in the heat exchanger 105, condensation is likely to occur. The parallel vertical channels in which warm, humid air passes through the heat exchanger 105 are separated by horizontal channels through which intake air 100 passes.

Having the heat exchanger 105 located between the drum 102 and the blower intake, for a dryer with the drum airflow direction 107 from rear to front, allows for the heat exchanger 105 to be mounted close to the front of the dryer. Since the lint trap won't capture all of the lint generated, some of the lint will end up in the heat exchanger 105. There are a few options to deal with lint accumulation in the heat exchanger 105. The first option is to insert a second lint trap with a fine filter in front of the heat exchanger 105, as to further limit the build-up of lint on the heat exchanger 105 surface and channels. A second option is to allow for the heat exchanger 105 to be removable, so that is can be routinely cleaned or rinsed. In both scenarios, it is beneficial to have front access to the heat exchanger 105, since it could be easily accessible to an operator. A third option may also be employed, and that option is to circulate water into top of the heat exchanger 105 at the end of a drying cycle (or on command), to carrying away accumulated lint. This water circulation can be managed automatically by the dryer, or manually by an operator pouring water directly onto the heat exchanger 105, or into tubing that leads to the heat exchanger 105.

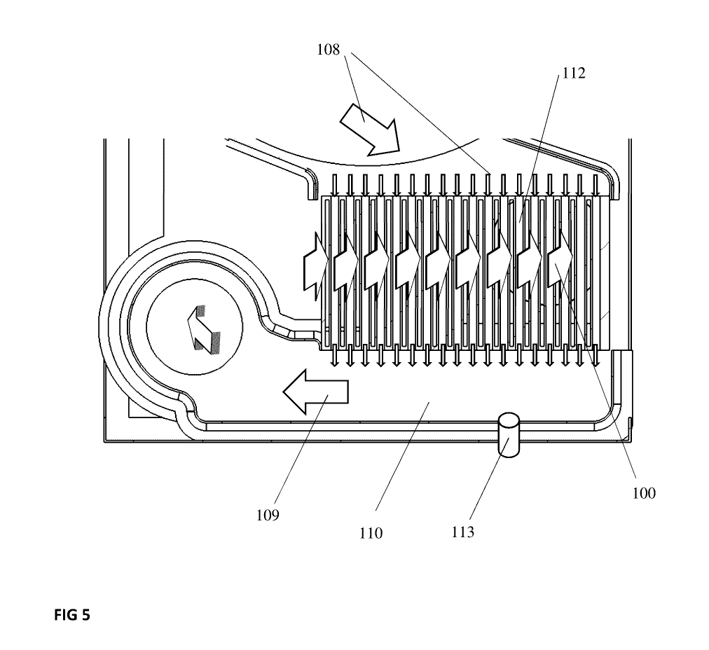

Constructing the heat exchanger 105, as presented in a heat exchanger cross-sectional view in FIG. 5, so that the warm air 100 passes through multiple parallel vertical channels 112, allows for condensate to more readily drain out of the heat exchanger 105, since the airflow drag and gravity both work in tandem to drive liquid to the bottom of the heat exchanger 105. At the bottom of the baffle 110 connecting the heat exchanger 105 to the blower will likely require a condensate drainage port 113, along with a collection pan (not shown), so that liquid accumulation doesn't spill out of the dryer or enter the blower. The liquid removal from the collection pan can be managed by human interaction or automatically with a pump. In condenser dryers, condensate removal is commonly addressed. If the vertical channels are constructed of metal foil, for instance aluminum, it may be beneficial to apply a hydrophilic coating to the surface, as is commonly done in HVAC evaporator coils. The hydrophilic coating helps prevent the formation of liquid droplets inside the channels, and bridging, by promoting the wettability of the fin by the condensate.

The embodiment of the heat exchanger 105 represented has a width of 375 mm, a height of 200 mm and a depth of 75 mm. The warm, humid air 108 passes through the face that is 200 mm×75 mm, and the intake air 100 passes through the face that is 375 mm×200 mm. In this configuration, the inlet air 100 approach velocities are smaller than the warm humid air 108 approach velocities, therefore leading to smaller pressure losses on the inlet air 100 than the exhaust air 108. The channel 112 size through which the warm humid air 108 passes may be greater than the channel size through which the intake air 100 passes, since the condensation heat transfer plays an important role, and because the warm humid air 108 velocity is greater. In some embodiments, the channels 112 of the warm humid air 108 may be in the range of 1.8 mm to 3.5 mm, where the channels for the intake air may be from 1.2 mm to 2.0 mm.

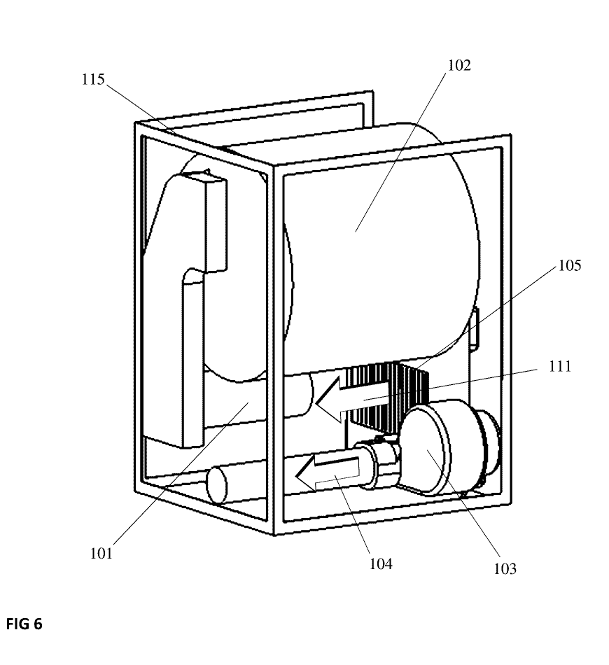

Since the pressure loss on the intake air 100 side of the heat exchanger 105 may be designed to be small, due to a relatively large cross-sectional area and narrow depth, the air flow 111 through this face may be driven by a slight negative pressure on the inside of the cabinet, with no direct ducting between the heat exchanger 105 and the heating tube 101, as depicted in FIG. 6. The negative pressure results from the air being pulled through the heating tube 101, from inside the cabinet 115, and the cabinet 112 having minimal openings to the external environment (not depicted), except through the heat exchanger 105. In order to make this approach work, the pressure loss through the intake heat exchanger face must be small, for instance, less than 0.15 inches of water at 150 cubic feet per minute, and the cabinet 115 must be reasonably sealed. Large openings in the cabinet 115 can reduce the airflow 111 through the heat exchanger 105, thus reducing the efficiency gains. Additional care must be taken in the design of the cabinet 115 to limit the size of the potential openings, including seams between faces of the cabinet 115.

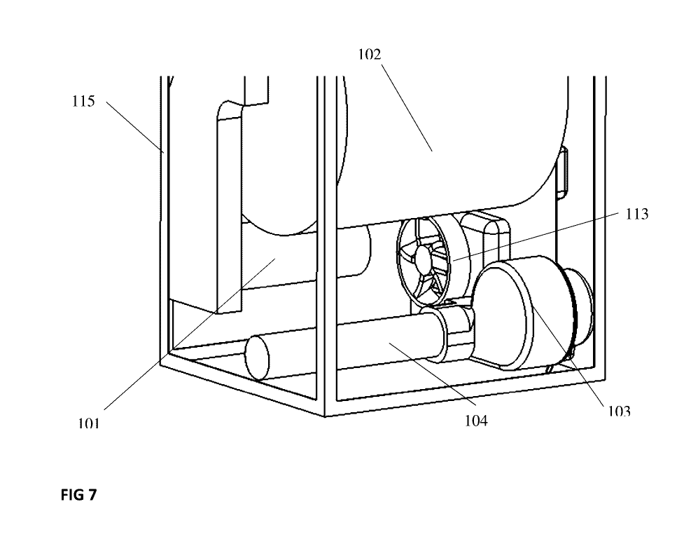

To reduce the need to have good sealing of the cabinet 115, which is necessary to create an overall negative pressure within the cabinet 115, a second embodiment of the present invention has an additional fan 113 as presented in FIG. 7. This fan 113 may be added to pull the intake air through the heat exchanger 105 (hidden by fan). This fan 113 may require a fan shroud to create a negative pressure between the heat exchanger 105 and the fan 113. In this arrangement, the fan 113 may be sized to match the airflow provided by the blower 103, as to keep the pressure within the cabinet 115 nearly neutral with respect to the external pressure surrounding the cabinet 115. Since the airflow through the blower 103 is dependent on items such as the external exhaust duct length and number of turns in this duct, as well as the content of the load within the drum 102, it is likely that the pressure within the cabinet 115 will vary from slightly negative to slightly positive. Since the heat exchanger 105 is located on the front panel, the fan 113 may be positioned in a way in which the axis of rotation is parallel to the axis of rotation of the blower 103 and the drum 102. The tumbling motion of the drum 102 is commonly driven, via a belt (not represented), by the same motor (not represented) that drives the blower 103. Since the fan's 113 rotational axis is parallel to the drum 102 and the blower's 103 axes of rotation, it is convenient to drive the fan from the same motor by a belt. The addition of the fan 113 can enable a denser fin spacing and deeper heat exchanger 105, thus promoting more heat transfer surface area and the ability to recover more of the available heat.

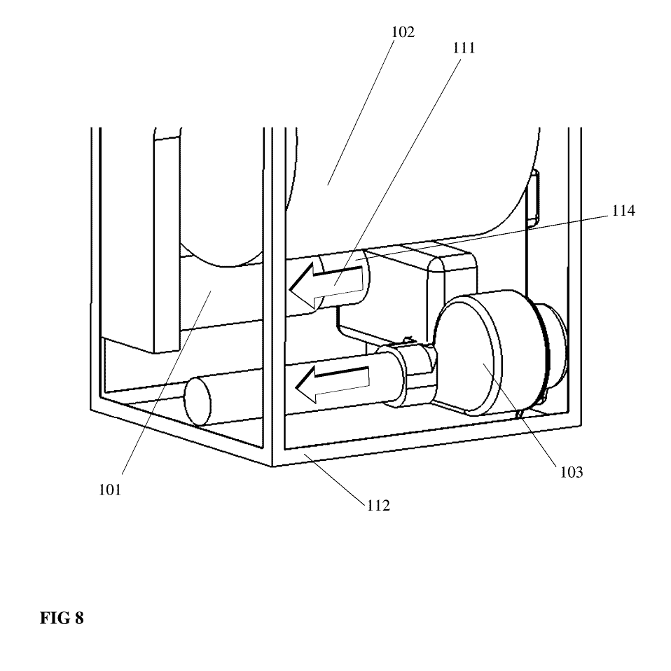

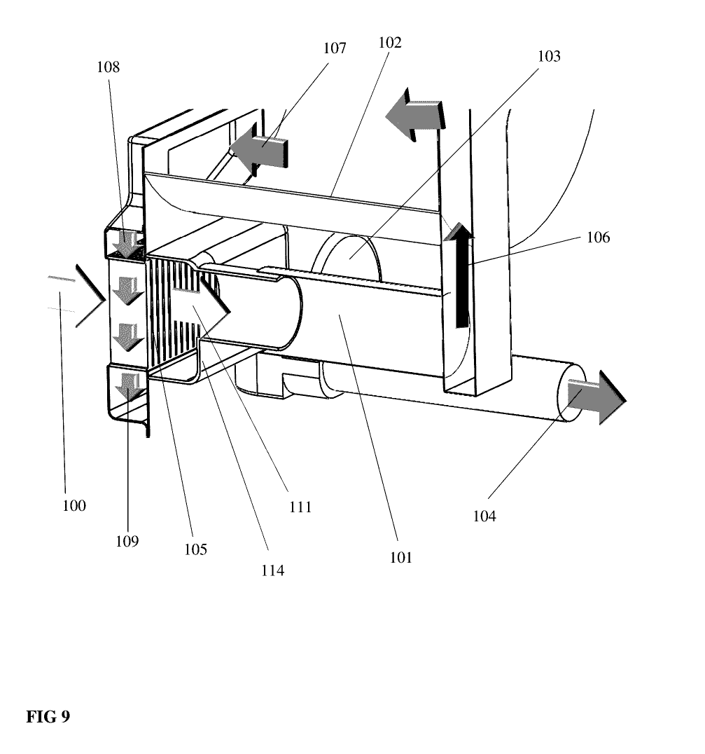

As an alternative to the addition of a fan 113, the airflow 111 between the heat exchanger 105 and the heating tube 101 can be guided by a duct 114 in another embodiment of the present invention. An isometric view of this implementation from the rear of the dryer is presented in FIG. 8. A cross-sectional view of the ducted airflow pattern is also presented in FIG. 9. The intake air 100 passes through the heat exchanger 105, and that same airstream 111 leaves the heat exchanger through a duct 114 and enters the heating tube 101. The hot air 106 leaving the heating tube 101 then enters the drum 102. The airflow 107 within the drum 102 cools as it picks up moistures from the contents (not shown) within the drum 102. The warm humid air 108 then passes through the heat exchanger 105, where it exchanges heat with the intake air 100. The warm, humid air 109 leaving the heat exchanger 105, is pulled through the blower 103, and then exhausts 104 from the dryer. In the third embodiment, since there is a motor (not shown) that drives the blower 103 and the drum 102, that generates heat, it may be necessary to added some ventilation to the cabinet 102, or allow some intake air 100 to bypass the heat exchanger 105 to allow for the cooling of the motor.

In all embodiments, the heat exchanger 105 will increase the impedance to the airflow through the drying cycle. There may require an increase in the blower 103 capacity, if it is desired to maintain a constant airflow through the system. If the same blower 103 is used, a lower power heating element may be used, so that the temperature of the heating element doesn't exceed a maximum temperature, since a lower airflow will reduce the cooling of the heating element. Similarly, in a gas dryer, a lower gas flow rate may be necessary to limit the maximum temperatures encountered. Since the heat exchanger 105 preheats the air into the heating tube 101, a reduction of heating element power or gas flow of approximately twenty percent is expected to have little consequence on the drying time, since approximately the same heat load is recovered by the heat exchanger 105.

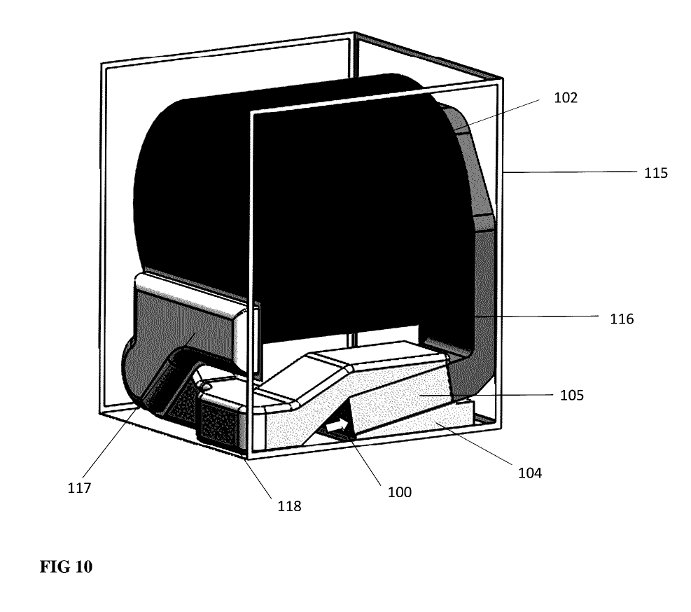

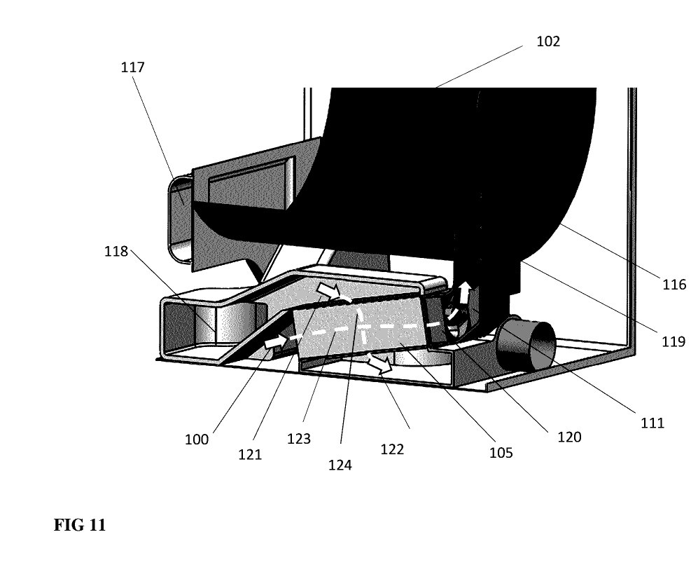

In an additional set of embodiments, the heat exchanger 105 can be integrated, via ducting, to the drum intake ducting 116, which receives intake air 100 after preheating. The heat exchanger 105, is connected to the blower 103 exhaust ducting 118, as represented in FIG. 10. In this, fourth embodiment, the drum 102 exhaust is directly ducted 117 to the blower (not shown) intake, as is typically done with conventional tumble dryers. A cross sectional view of this embodiment is presented in FIG. 11. In this view, the flow path 123 of the intake air 100 as it collects heat from the warm humid exhaust air 121 leaving the blower is presented. In this embodiment, preheated air 111 passes through a booster fan 120 which helps overcome the pressure loss from the heat exchanger 105. The intake air flow path 123 is longer than the exhaust air flow path 124 inside the heat exchanger 105. In this configuration, the intake air 100 has a larger pressure loss to overcome than the exhaust air 121, which is addressed by the booster fan. Additionally, the exhaust airflow path 124 generally flows from top to bottom, in the direction of gravity. Since the humidity in the exhaust air 121 will condense as it passes through the heat exchanger 105, having air flow and gravity aligned will help promote the drainage of condensate out of the heat exchanger 105. It will be required to have a condensate collection mechanism under the heat exchanger 105 to collect water build up. This water collection mechanism may be manually removed by an operator, or may include the addition of a pump which connects to an external to the cabinet 115 drain, to automatically remove water.

In this, fourth, embodiment, the heating elements 119 are located in the rear drum intake duct 116. This duct work 116 surface can be hot. In a conventional dryer, the dryer intake air comes into the chassis 115 adjacent to the drum intake duct 116, so that the heat lost from this ducting goes into preheating the air that will pass over the heating elements 119, nearly offsetting such effect. When a passive indirect heat exchanger 105 is utilized, any heat lost from the intake duct 116, elevates the air temperature into the heat exchanger 105, and reduces the amount of heat that can be recovered. Therefore, to maximize the performance of the dryer, the intake air 100 should enter the chassis at a location away from the drum intake duct 116 and the drum intake duct 116 should be insulated to prevent heat loss.

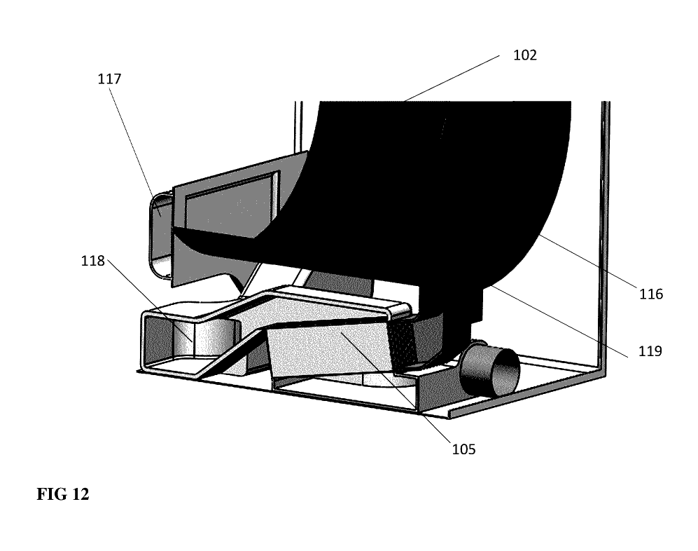

A fifth embodiment is presented in FIG. 12. The fourth embodiment and fifth embodiment are identical except that a booster fan 120 is not utilized in the latter. When a booster fan 120 is not utilized, the heat exchanger may need to be adjusted, to loosen the fin density, as to limit the impedance to the system airflow. Alternatively, a designer may decide that less airflow is permissible, which would result in lowering the heat input and lengthening dryer times.

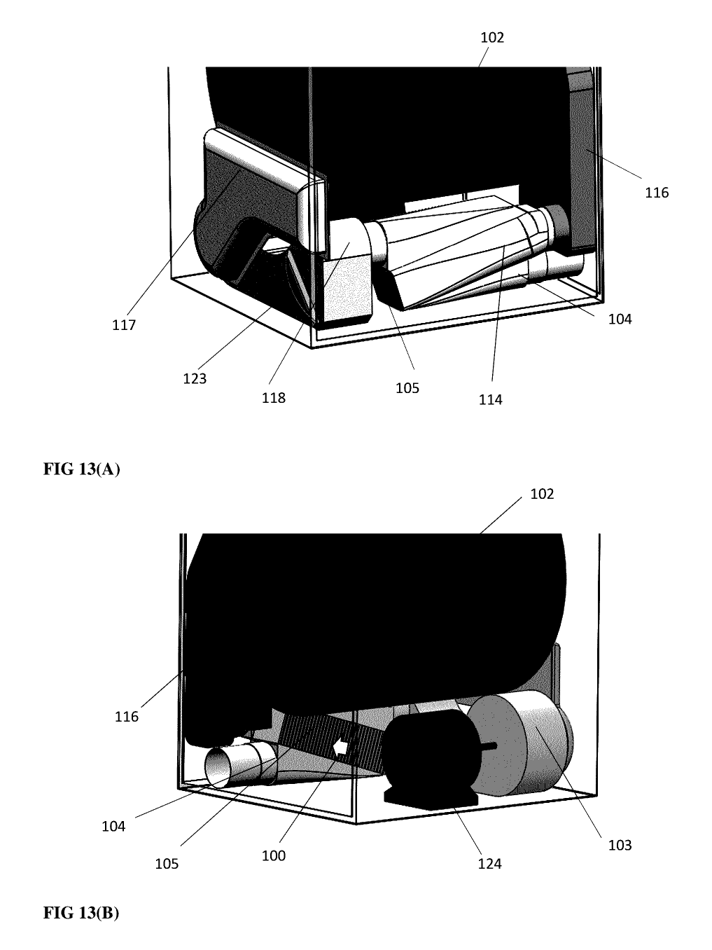

A front isometric view FIG. 13A and rear isometric view FIG. 13B of a sixth embodiment of the present invention represent another implementation of a heat exchanger 105. In this embodiment, the heat exchanger intake air 100 enters the heat exchanger 105 from the motor 124 side of the heat exchanger 105. The drum rotation helps promote heat generated by the motor 124 to enter the heat exchanger 105 intake by creating a current of airflow from the motor 124 to the intake. The motor 124 can account for 3 to 8 percent of the energy consumed by the dryer during operation, so utilizing this heat is beneficial to dryer efficiency. In this orientation, the exhaust and intake airflow paths are both relatively short, and the fin stack is deep, which allows for a relatively large cross-section on both the intake and exhaust air resulting in a low airflow impedance. Low airflow impedance is beneficial for integration where only the main dryer blower 103 is used to drive airflow. The humid exhaust air flows through the heat exchanger 105 from top to bottom, and allows for good condensate drainage. The warm humid air exhaust face of the heat exchanger 105 is pitched, where the side closest to the front of the cabinet 115, is closer to the cabinet 115 floor than the opposing side. The angle created between the heat exchanger 105 and cabinet 115 floor can be between 0 and 30 degrees. In this embodiment, the heating elements 119 (hidden) can be contained in the drum intake ducting 116.

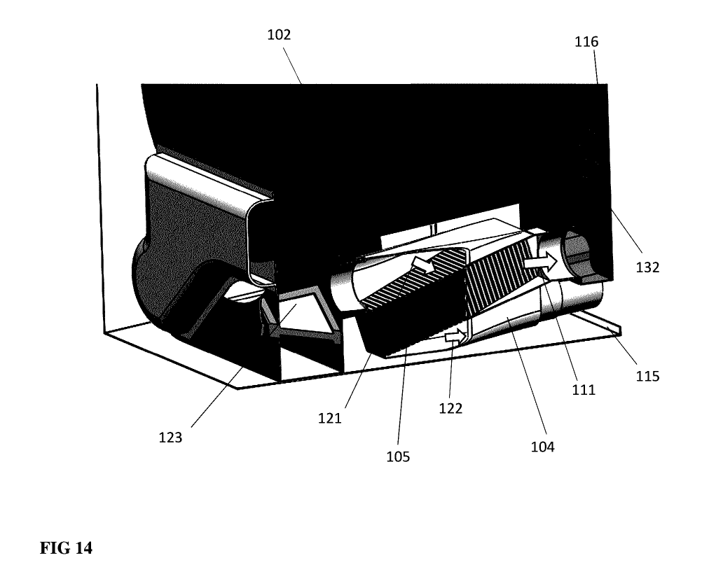

A cross-sectional view of the dryer cabinet in the sixth embodiment is presented in FIG. 14. The warm humid air 121 downstream of the filter 123 enters the heat exchanger's 105 top face, and exhausts 122 the bottom face and then exits the dryer cabinet 115 through exhaust ducting 104. The intake air 100 (hidden) passes through the heat exchanger 105, and exits as preheated air 111 to the dryer's heating elements 132 located in the drum intake duct 116.

In order to recover a substantial amount of heat from a dryer venting 80 to 150 cubic feet per minute of airflow, the heat exchanger 105 is important. The heat exchanger 105 depicted in FIG. 14 consists of parallel plates, each plate having a dimension of 100 mm×100 mm×0.2 mm thick. The plates have a pitch of 4.0 mm and form a stack that is 300 mm long. Larger plate dimensions are possible and will yield better heat recovery performance, however, a volume greater than 125 mm×250 mm×350 mm is difficult to implement within the available volume in dryers typically in the residential marketplace, resulting in the growth of the dryer cabinet 115. The fin pitch may be decreased to approximately 2.0 mm, to increase the heat exchanger 105 performance, however further reductions in the fin pitch can choke the overall airflow through the dryer, resulting in reduced drying performance and a possible safety concern.

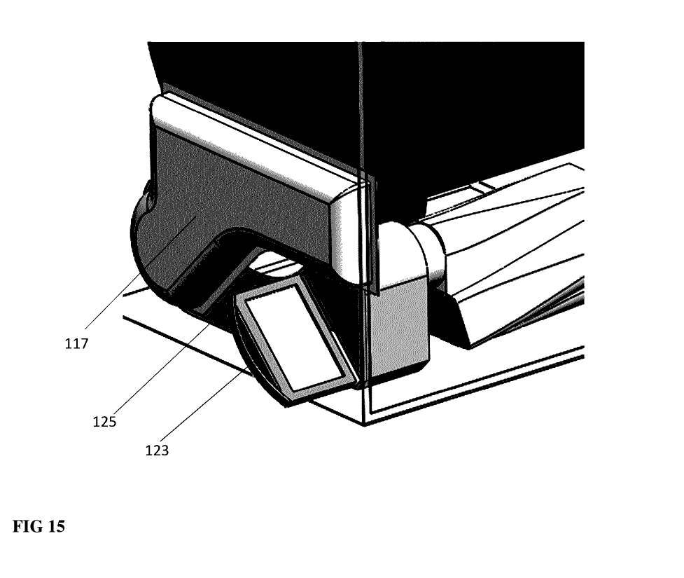

A removable lint filter 123 is represented in FIG. 13A in the installed position and in FIG. 15 in the removed position. This filter 123 and be in addition to a lint trap (not shown) installed in the drum exhaust to blower intake duct 117, or it can be in lieu of this lint trap. The filter is needed to prevent lint buildup on the heat exchanger 105. This lint filter 123 is oriented in a manner that the airflow leaving the blower 103 goes diagonally upward when passing through the filter 123. In this orientation, any debris or lint that falls off of the filter 123 when it is removed, will fall into the space in the duct 125 between the filter 123 and the blower 103. Debris build up in this position is beneficial because the filter 123 can still act as a barrier to heat exchanger 105 fouling upon subsequent operation of the dryer. If the filter 123 is a secondary barrier to a primary lint trap, an alternative configuration is to remove this filter and add a feature of a water spray to clean the heat exchanger of any built up fouling.

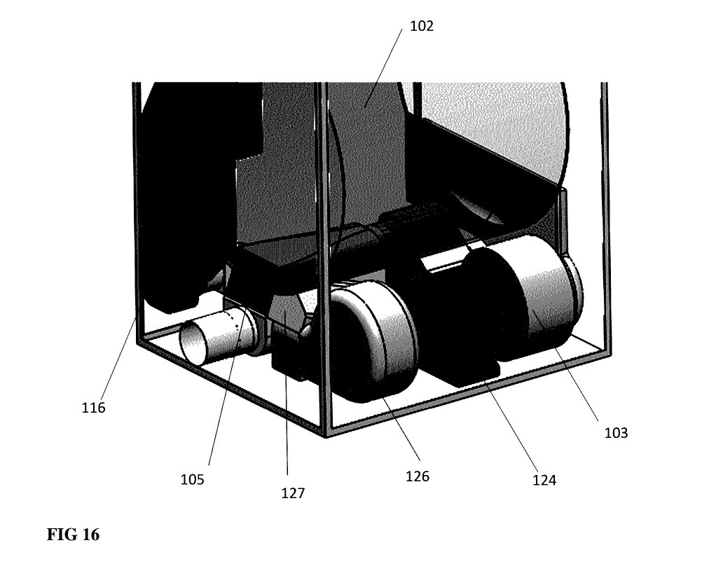

A rear isometric view of a seventh embodiment of the present invention is presented in FIG. 16. A booster blower 126 is powered by the same motor 124 that drives the main blower 103 and tumbler belt (not shown). The booster blower 126 provides intake air to the heat exchanger 105 through a heat exchanger intake duct 127. The intake air is preheated through the heat exchanger 105 prior to entering the drum intake duct 116 containing heating elements 132. In this embodiment, the intake of the booster blower 126 is positioned adjacent to the motor (hidden), so that the heat from the motor is directly taken into the process air stream so that it can be fully utilized for the drying cycle. To get the maximum performance, the pressure inside the drum 102 should be as close to neutral with the pressure within the cabinet, as to limit air leakage into or out of the drum 102 from the slip seals along the drum's 102 edges. In the case that the drum's pressure is more negative than the cabinet pressure, the total heat recovery potential of the heat exchanger 105 is not utilized, some of the airflow inside the drum 102 doesn't pass through the heat exchanger 105. In the case where the drum 102 is slightly pressurized, heated air can be wasted, which can be a steeper energy penalty than the former case.

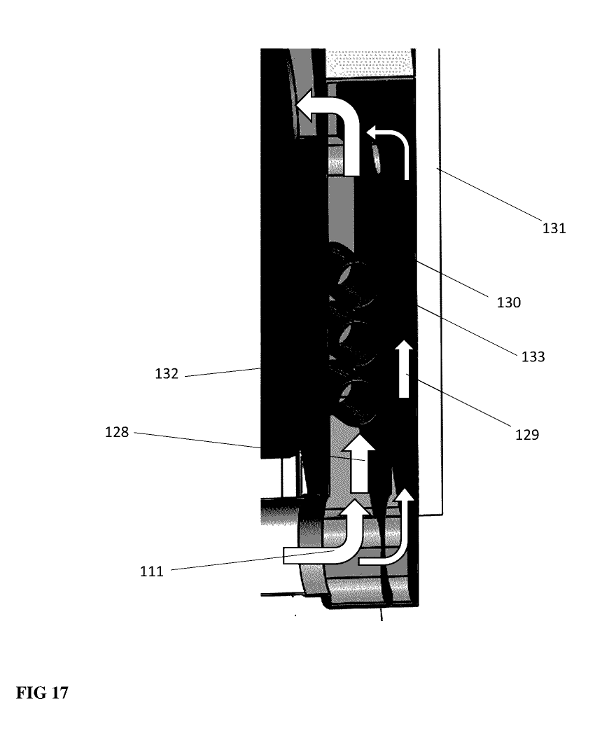

The drum intake duct 116 in accordance with the seventh embodiment is presented in FIG. 17. The preheated intake air 111 enters the intake duct 116 and splits into a first airstream 128 that goes across the heating elements 132 and a second airstream 129 that does not. The two airstreams are divided by a partition 130, which allows the airstreams to mix prior to entering the drum 102. Since the surface temperature of the intake duct 116 can get very hot, upwards of 200 C or greater, when air introduced to the cabinet does not pass over it; the second airstream 129 acts as a coolant to the duct work, reducing the outer duct 133 surface temperatures, which directly reduces heat losses. The partition 130 should be placed in a location that allows for seventy (70) to ninety (90) percent of the intake airflow 111 to pass over the heating elements 132. To help further reduce the heat losses, a layer of insulation 131 may be added to the rear surface 133 of the intake duct 116. In addition to preventing heat loss, this insulation 131 may also aid in reducing the surface temperatures, which can be a consideration for safety.

Further improvements may be made to the heat exchanger implementation into the dryer with two blowers. When the booster blower 126 is at the rear of the cabinet 115 and the main blower 103 is positioned in the front, the heat exchanger 105 may be configured to allow for counter flowing air, with the dry air flowing from the rear of the cabinet to the front and the humid air flowing from the front of the cabinet to the rear. A counter-flow heat exchanger can enable additional heat recovery from the dryer towards the end of the drying cycle when the relative humidity of the drum exhaust air drops and the temperature rises.

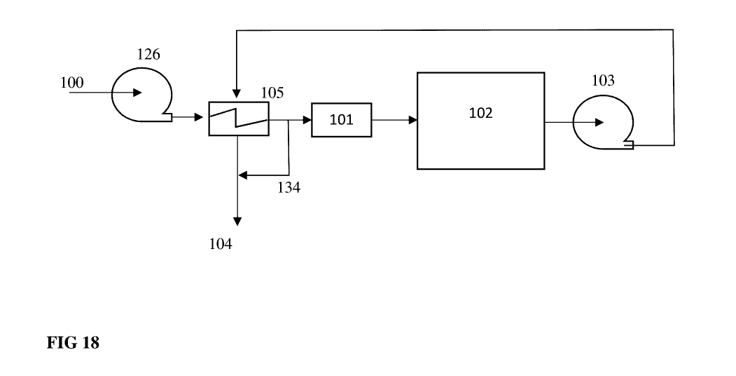

Another consideration when implementing heat recovery from the exhaust stream is the risk of condensation build up in the dryer ductwork connecting the dryer exhaust 104 to the exhaust of the building that contains the dryer. The warm, humid air exiting the drum and entering the heat exchanger 105 has a higher temperature and lower relative humidity than the air exhausting the heat exchanger. Additional heat losses in the ducting exterior to the dryer cabinet may be more likely to produce condensation, because of the higher relative humidity level. A method to combat this effect is directing 134 some of the preheated intake air to mix with the heat exchanger exhaust air prior to exhausting the dryer 104, as represented in FIG. 18. The preheated air 100 will have a much lower relative humidity than the exhaust air, thereby greatly reducing the risk of condensation in the external ductwork. A booster blower or fan 126 will be required to create the pressure head necessary to drive the mixing of the preheated air 100 with the heat exchanger 105 exhaust air, if the air mixing is done according to the embodiment represented in FIG. 18. A booster blower may be avoided if the heat exchanger 105 is placed between the drum 102 exhaust and main blower 103 intake, since the main blower 103 intake will have a negative pressure, creating a low pressure that may be utilized to drive the mixing process.

While the present embodiments have been disclosed according to the preferred embodiments of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible passive heat recovery methods and systems available, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

I claim:

1. A vented clothes dryer comprising:
a first blower configured to transport dry air to a heat exchanger;
a second blower configured to transport humid air from a drum positioned within the cabinet to the heat exchanger, wherein the heat exchanger exchanges heat between the dry air and the humid air while preventing the dry air from mixing with the humid air;
a heater configured to heat dry air received from the heat exchanger and transport the heated dry air to the drum, wherein energy is exchanged between the heated dry air from the heat exchanger and damp fabric positioned within the drum, thereby generating humid air.

2. The vented clothes dryer of claim 1, wherein the first blower, the second blower, the heat exchanger and the heater are positioned in a cabinet having air intake perforations and the first blower is configured to transport dry air through the air intake perforations to the heat exchanger.

3. The vented clothes dryer of claim 1, wherein a portion of the dry air exhausting the heat exchanger is mixed with the humid air exhausting the heat exchanger prior to exhausting a cabinet in which the heat exchanger, the drum, the first blower and the second blower are enclosed.

4. The vented clothes dryer of claim 1, wherein a portion of the dry air exhausting the heat exchanger bypasses the heater and flows over ductwork positioned between the heater and drum prior to entering the drum.

5. The vented clothes dryer of claim 1, wherein the first blower and the second blower are driven by the same motor.

6. The vented clothes dryer of claim 1, where the first blower and the second blower are driven by the same motor and mechanically coupled by a belt.

7. The vented clothes dryer of claim 1, wherein the humid air within the heat exchanger flows in the direction of gravity.

8. The vented clothes dryer of claim 1, wherein the humid air within the heat exchanger flows in the direction of gravity, and the heat exchanger is positioned below the drum.

9. The vented clothes dryer of claim 1, wherein the heat exchanger consists of parallel plates having a pitch between approximately 2.0 mm and 4.0 mm, a height between approximately 75 mm to 125 mm, a width between approximately 100 mm to 250 mm and a length between approximately 250 mm to 350 mm.

10. The vented clothes dryer of claim 1, wherein the dry air entering the first blower is allowed to pass over a motor, thereby collecting heat generated by the motor before being transported by the first blower to the heat exchanger.

11. The vented clothes dryer of claim 1, wherein the heat exchanger, the heater, the drum, the first blower and the second blower are positioned within a cabinet having air intake perforations positioned on the rear side of the cabinet, below the drum, and on the opposing side of the cabinet from the heater.

12. The vented clothes dryer of claim 1, wherein the heat exchanger, the heater, the drum, the first blower and the second blower are positioned within a cabinet, and the heat exchanger is configured to be a counter-flowing heat exchanger, with the dry air flowing from the rear of the cabinet to the front, and the humid air flowing from the front of the cabinet to the rear.

13. A vented clothes dryer comprising:
a first blower, a drum, a heater and a heat exchanger positioned within a cabinet, wherein;
the drum accepts dry air from the heater, allows energy to be exchanged between heated air and damp fabric positioned within the drum, and exhausts humid air into the heat exchanger,
the heat exchanger exchanges heat between dry intake air and humid air while preventing the dry air and humid air from mixing,
a heater accepting dry air from the heat exchanger and exhausting dry air to the drum, and
the first blower accepts humid air from the heat exchanger and exhausts humid air outside the cabinet.

14. The vented clothes dryer of claim 13, wherein the heat exchanger is positioned in the front of the cabinet and accepts dry air through perforations positioned in the front of the cabinet.

15. The vented clothes dryer of claim 13, wherein the humid air within the heat exchanger flows in the direction of gravity.

16. The vented clothes dryer of claim 13, wherein the first blower accepts a portion its air from a portion of the dry air exhausting the heat exchanger.

17. The vented clothes dryer of claim 13, wherein a second blower accepts dry air from the heat exchanger and exhausts dry air to the heater.

18. The vented clothes dryer of claim 12, wherein a second blower accepts dry air from the heat exchanger and exhausts dry air to the heater, and the first and second blower are driven by the same motor and are mechanically coupled by a belt.
